(19) United States
(12) Patent Application Publication
(10) Pub. No.: US 2026/0001591 A1
(43) Pub. Date: Jan. 1, 2026

(54) VEHICLE AIR FLOW STRUCTURE

(71) Applicant: NISSAN NORTH AMERICA, INC., Franklin, TN (US)

(72) Inventors: Bradley CHISHOLM, Commerce Twp, MI (US); Justin Bradley HENKER, Farmington Hills, MI (US); Scott MCLAREN, Wixom, MI (US)

(21) Appl. No.: 18/757,216

(22) Filed: Jun. 27, 2024

(51) Int. Cl. B62D 25/08; B60H 1/00; B60H 1/28

(52) U.S. Cl. CPC B62D 25/081; B60H 1/00378; B60H 1/00564; B60H 1/28

(57) ABSTRACT

A vehicle air flow structure includes a vehicle body structure, an air handling structure and a cowl box structure of a vehicle. The vehicle body structure has a passenger compartment and a hood that covers an underhood area forward of the passenger compartment with a dashwall located between the passenger compartment and the underhood area. The dashwall further has an opening. The air handling structure is attached to the dashwall. The cowl box structure is located at least partially within the underhood area and is configured to draw air from the underhood area such that prior to being drawn into the cowl box structure air passes through the underhood area and into the cowl box structure through the opening in the dashwall and into the air handling structure.

### BACKGROUND

### Technical Field

The present disclosure generally relates to a vehicle air flow structure. More specifically, the present disclosure relates to an air flow structure that directs air from an underhood area of a vehicle into an air handling structure of an HVAC system within the vehicle.

### Background Information

Electric vehicles do not include hydrocarbon consuming motors. Therefore, an underhood area of a vehicle (where an engine compartment might otherwise be defined) has no source of contamination as would otherwise be present from an internal combustion engine such as exhaust leaks, fuel leaks and/or oil leaks. Therefore, air within the underhood area is generally as clean as the ambient air outside of the vehicle.

### SUMMARY

It has been discovered that air within an underhood area of a vehicle (space under the front hood of a vehicle) is generally clean and contaminant free in electric vehicles and can be allowed to flow into an air handling system of a vehicle HVAC system.

In view of the state of the known technology, one aspect of the present disclosure is to provide a vehicle air flow structure with elements of a vehicle body structure, an air handling structure and a cowl box structure of a vehicle. The vehicle body structure has a passenger compartment and a hood that covers an underhood area forward of the passenger compartment with a dashwall located between the passenger compartment and the underhood area. The dashwall further has an opening. The air handling structure is attached to the dashwall. The cowl box structure is located at least partially within the underhood area and is configured to draw air from the underhood area such that prior to being drawn into the cowl box structure air passes through the underhood area and into the cowl box structure through the opening in the dashwall and into the air handling structure.

### BRIEF DESCRIPTION OF THE DRAWINGS

Referring now to the attached drawings which form a part of this original disclosure:

FIG. 1 is a side view of a vehicle powered by an electric motor, in accordance with a first embodiment;

FIG. 2 is a perspective view of the vehicle depicted in FIG. 1 showing air flowing into an inlet opening defined at a lower of the front of the vehicle such that the air flows into an underhood area of the vehicle in accordance with the first embodiment;

FIG. 3 is a cross-sectional view of the forward portion of the vehicle taken along the line 3-3 in FIG. 2, showing the inlet opening, an electric motor within the underhood area beneath the hood of the vehicle, a cowl box structure and an air handling structure of an HVAC system in accordance with the first embodiment;

FIG. 4 is a cross-sectional perspective view of the underhood area of the vehicle showing the cowl box structure and portions of the air handling structure of the HVAC system in accordance with the first embodiment;

FIG. 5 is another cross-sectional perspective view of a portion of the underhood area of the vehicle showing a cowl box structure and portions of the air handling structure of the HVAC system in accordance with a second embodiment;

FIG. 6 is a cross-sectional perspective view of the forward portion of the vehicle similar to FIG. 5, showing a portion the underhood area beneath the hood of the vehicle, the cowl box structure and the air handling structure of an HVAC system with a duct installed within the cowl box structure in accordance with a third embodiment;

FIG. 7 is another cross-sectional perspective view of the forward portion of the vehicle similar to FIG. 6, showing the portion the underhood area beneath the hood of the vehicle, the cowl box structure and the air handling structure of an HVAC system with an interior of the duct within the cowl box structure shown in cross-section in accordance with the third embodiment;

FIG. 8 is a cross-sectional view of the vehicle similar to FIG. 3, showing the inlet opening, the electric motor within the underhood area beneath the hood of the vehicle, the cowl box structure and an air handling structure of an HVAC system with an air duct installed above the electric motor providing air to the cowl box structure in accordance with a fourth embodiment;

FIG. 9 is a perspective view of a vehicle showing air flowing into a cowl area at the lower end of a windscreen and an inlet opening defined at a lower of the front of the vehicle such that the air flows into an underhood area of the vehicle in accordance with a fifth embodiment; and

FIG. 10 is a schematic cross-sectional view of the forward portion of the vehicle taken along the line 10-10 in FIG. 9, showing a cowl area above a cowl box structure and an air handling structure of an HVAC system with a mixing valve that adjusts and air flow mixture from air entering the cowl box structure through the cowl area and air entering the cowl box structure from the underhood area in accordance with the fifth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

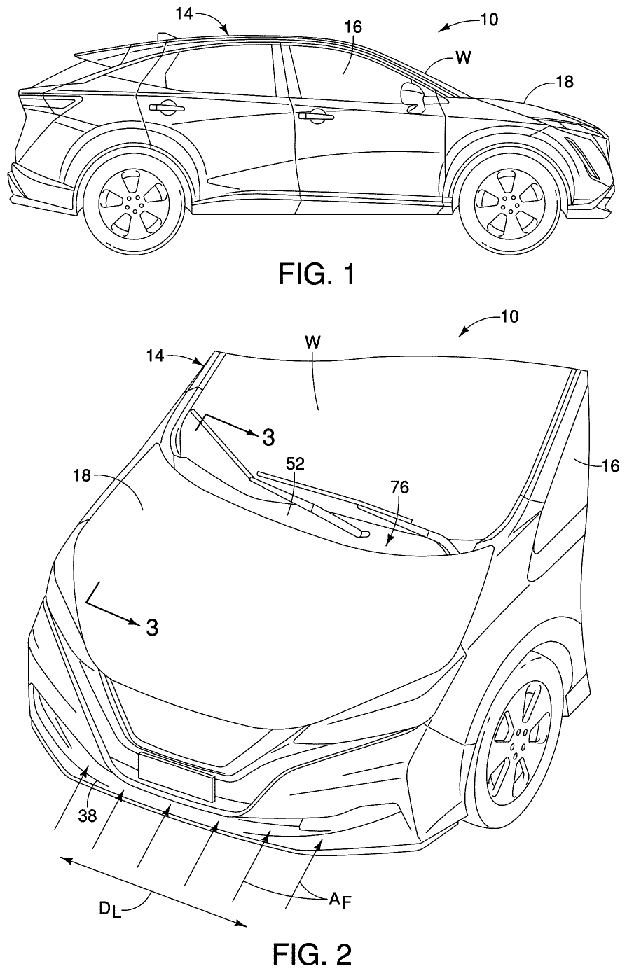

Referring initially to FIG. 1, a vehicle 10 is illustrated in accordance with a first embodiment. As shown in FIGS. 2, 3 and 4, the vehicle 10 includes a vehicle air flow structure vehicle 12, as is described in greater detail below.

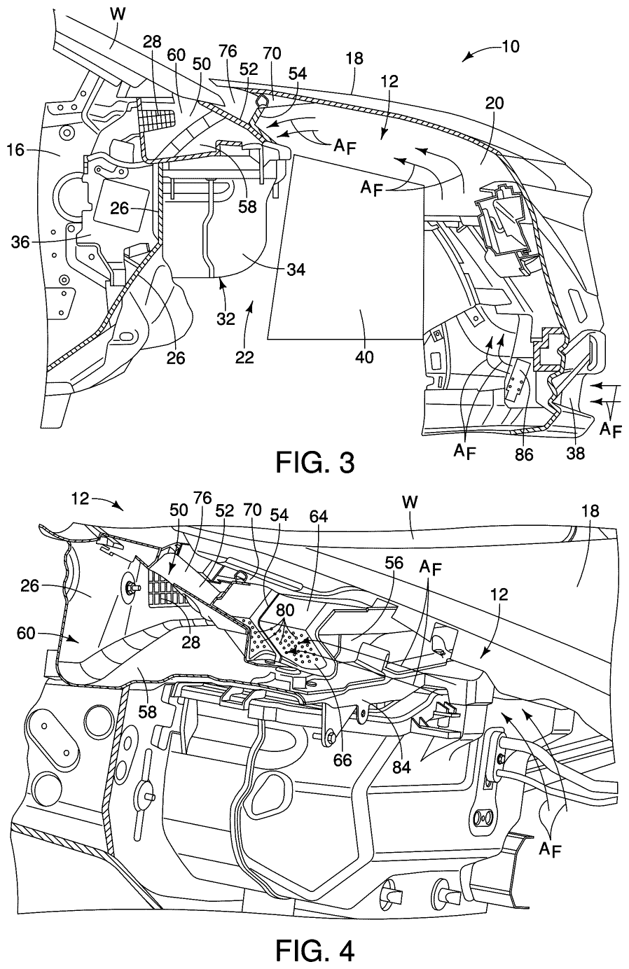

The vehicle 10 has a vehicle body structure 14 that includes body panels that define a passenger compartment 16, a hood 18 and an underhood area 20 beneath the hood 18. The underhood area 20 includes a power plant compartment 22 (also known as an engine compartment). As shown in FIGS. 3 and 4, the vehicle body structure 14 includes a dashwall 26 that separates the passenger compartment 16 from the power plant compartment 22.

In the drawings, the vehicle 10 is depicted as an SUV (sports utility vehicle) but can alternatively be a coupe, a sedan, a pickup truck or a commercial vehicle.

The dashwall 26 has an opening 28. The vehicle body structure 14 further includes an air handling structure 32, as shown in FIGS. 3 and 4. The vehicle air flow structure vehicle 12 includes features that ultimately direct air in the underhood area 20 into the air handling structure 32 where air is conditioned (heated or cooled) and then directed into the passenger compartment 16, as described in greater detail below.

The air handling structure 32 that has a first part 34 located within the power plant compartment 22 (the underhood area 20) and a second part 36 that is located within the passenger compartment 16. The air handling structure 32 is attached to the dashwall 26 and includes a conventional fan (not shown in FIGS. 1-4), and a conventional heat exchanger (not shown in FIGS. 1-4) that is part of an HVAC system (heating, ventilation and air conditioning system).

The air handling structure 32 includes many conventional features, such as ducts and air flow valves (not shown) that direct conditioned air (heated or cooled) to various locations within the passenger compartment 16. Since these conventional features are well known, further description is omitted for the sake of brevity.

As shown in FIGS. 2 and 3, the vehicle air flow structure vehicle 12 is configured such that air flowing toward the front of the vehicle 10 enters an air inlet opening 38 located at a lower front area of the underhood area 20 at the front of the vehicle 10. The air inlet opening 38 provides fresh air to the underhood area 20. The basic directions of airflow AF into and through the underhood area 20 is shown in various drawings.

The hood 18 is movable between an open orientation (not shown) exposing the underhood area (the power plant compartment 22) and a closed orientation, as shown in FIGS. 1-4. The hood 18 is a conventional vehicle element, and therefore further description of the hood 18 is omitted for the sake of brevity.

The power plant compartment 22 within the underhood area 20 preferably includes an electric motor 40 that is attached to various structural elements of the vehicle body structure 14 in a conventional manner. Preferably, the electric motor 40 is the sole source of propulsion for the vehicle 10 and the vehicle body structure 14. Alternatively, a front electric motor and a rear electric motor can be employed within the vehicle 10. It should be understood that the electric motor 40 can alternatively be attached to areas of the vehicle body structure 14 other than the underhood area 20, such as a rearward trunk or cargo area or in a central area of the vehicle 10, depending upon the overall design and construction of the vehicle 10.

The vehicle body structure 14 further includes a cowl box structure 50 located at least partially within the underhood area 20. The cowl box structure 50 is configured to receive or draw air from the underhood area 20 such that prior to being drawn into the cowl box structure 50 air passes through the underhood area 20 along surfaces of the electric motor 40 and into the cowl box structure 50 and then to and through the opening 28 in the dashwall 26 and into the air handling structure 32.

The cowl box structure 50 is located at the forward lower end of the windscreen W and partially extends into the underhood area 20 and hence, the power plant compartment 22. At least a portion of the cowl box structure 50 is located below a rearward end of the hood 18.

The cowl box structure 50 includes several panels welded or otherwise fixedly attached to one another to form the cowl box structure 50. For example, the rear side of the cowl box structure 50 can be a separate panel, however in the depicted embodiments portions of the dashwall 26 define a rear side of the cowl box structure 50. The cowl box structure 50 further includes a main panel 52, an L-shaped panel 54, a front panel 56 and a lower panel 58, as shown in FIGS. 3 and 4. A tunnel 60 is defined within the cowl box structure 50. The tunnel 60 extends in a vehicle lateral direction D_{L}. from one end of the windscreen W to the other end thereof.

The main panel 52 is forwardly inclined in a downward direction toward the electric motor 40. The L-shaped panel 54 and the front panel 56 can be one element or a plurality of elements. The L-shaped panel 54 includes an upwardly extending portion 64 and a forwardly extending portion 66. The upwardly extending portion 64 is inclined such that the upper end thereof is further forward than a lower end thereof. The forwardly extending portion 66 of the L-shaped panel 54 is inclined in a downward and forward direction. The upper end of the upwardly extending portion 64 of the L-shaped panel 54 includes an elongated seal 70 that extends the width of the L-shaped panel 54 and most, if not all, of the width of the hood 18. The elongated seal 70 is positioned such that with the hood 18 in the closed orientation, the seal 70 is compressed between the underside of the hood 18 and the upwardly extending portion 64 of the L-shaped panel 54, thereby preventing air, rain water or moisture from entering the underhood areal 20 from a cowl area 76 above the cowl box structure 50. The seal 70 further prevents air from passing between the cowl area 76 and the underhood area 20.

The upwardly extending portion 64 of the L-shaped panel 54 and the main panel 52 of the cowl box structure 50 define the cowl area 76 above the cowl box structure 50. Further, the inclination of the upwardly extending portion 64 of the L-shaped panel 54 and the inclination of the main panel 52 of the cowl box structure 50 define a trough that directs water and debris that might collect in the cowl area 76 (above the cowl box structure 50) toward outer lateral sides of the vehicle body structure 14 where drain openings (not shown) are provided.

Portions of the forwardly extending portion 66 of the L-shaped panel 54 includes a plurality of openings 80. The openings 80 in the forwardly extending portion 66 of the L-shaped panel 54 are provided such that air within the underhood area 20 can pass through the openings 80 and into the tunnel 60 within the cowl box structure 50. Once within the tunnel 60, the air can pass through the opening 28 in the dashwall 26 and further into the air handling structure 32.

The lower panel 58 of the cowl box structure 50 extends from the dashwall 26 forward under the forwardly extending portion 66 of the L-shaped panel 54 and is fixedly attached to both by, for example, welding or adhesive materials. Beneath the forwardly extending portion 66 of the L-shaped panel 54, the lower panel 58 is further fixed to an attachment racket 84. The attachment bracket 84 is attached to the first part 34 of the air handling structure 32 within the underhood area 20.

Since the vehicle 10 is powered by a battery (not shown) and the electric motor 40, an internal combustion engine is not present within the power plant compartment 22 or the underhood area 20. Therefore, there are no hydrocarbon emissions or gases present within the underhood area 20. Thus, air can be drawn into the underhood area 20 through the inlet air opening 38 at the front of the vehicle 10, circulate along the front and upper surface of the electric motor 40, enter the openings 80 in the forwardly extending portion 66 of the L-shaped panel 54. Thereafter, air enters the tunnel 60 within the cowl box structure 50, then pass through the opening 28 in the dashwall 26 and into the air handling structure 32. Within the air handling structure 32, the air is heated or cooled as per settings made in a control panel of the HVAC system within the vehicle 10 and then blown via a fan to the desired area of the passenger compartment 16.

Because the electric motor 40 does not produce hydrocarbon based emissions, there are no hydrocarbon related noxious contaminants in the air passing through the powerplant compartment 22. Further, in many weather conditions, such as rain or snow, the air within the power plant compartment 22 typically has a reduced moisture content as compared to ambient air outside the vehicle 10. This is because the power plant compartment 22 has sufficient volume therein such that moisture in air within the power plant compartment 22 has an opportunity to partially dry partially due to condensation or as a result of being within a space that is separated from the ambient adverse weather conditions outside the vehicle 10.

As shown in FIG. 3, the vehicle body structure 14 includes a heat exchanger 86 located adjacent to and rearward of the inlet opening 38. The heat exchanger is part of the HVAC system and heats or cools air passing therethrough from the inlet opening 38.

Air from the underhood area 20 is relatively dry as compared to air in the vicinity of the cowl area 76. For example, if it is raining or snowing, air entering the underhood area 20 via the inlet opening 38 travels upward around the electric motor 40 and into the cowl box structure 50, as described above. The electric motor 40 produces a relatively small amount of heat, as compared to an internal combustion engine. In fact, electric motors 40 in electric vehicles generally operates at a few degrees above room temperature. Therefore, in cool or cold weather, heat generated by the electric motor 40 can slightly warm and dry the air from the inlet opening 38 within the underhood area 20. In warm or hot weather, the electric motor 40 does not necessarily heat warm air entering the underhood area 20 from the inlet opening 38 because the warm air entering the underhood area 20 is likely warmer than the electric motor 40.

HVAC systems are well known. The HVAC system (only partially shown) includes the heat exchanger 86 and a heat exchanger within the air handling structure 32. The HVAC system further includes a compressor (not shown) operated by electricity from a battery within the vehicle body structure 14, the battery providing power to the electric motor 40. Since HVAC systems and batteries in electric vehicles are conventional systems, further description of the HVAC system and the battery of the vehicle 10 are omitted for the sake of brevity.

### Second Embodiment

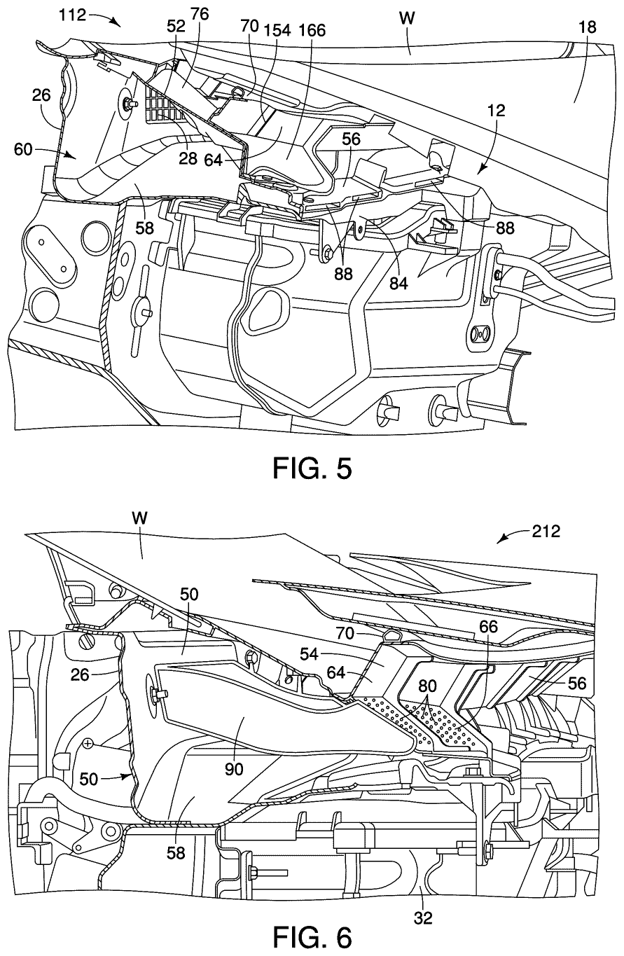

Referring now to FIG. 5, a vehicle air flow structure 112 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The vehicle air flow structure 112 includes many of the features of the vehicle air flow structure 12 of the first embodiment, such as the air handling structure 32 and the seal 70. However, the second embodiment includes a cowl box structure 150 that replaces the cowl box structure 50 of the first embodiment. The cowl box structure 150 has been modified (as compared to the cowl box structure 50 of the first embodiment) such that the openings 80 have been removed or sealed and functionally replaced with vents or ducts 88. The cowl box structure 150 includes the main panel 52, the front panel 56 and the lower panel 58, as described above with reference to the cowl box structure 50 of the first embodiment. However, in the second embodiment the L-shaped panel 154 replaces the panel 54 of the first embodiment.

As mentioned above, the L-shaped panel 154 does not include openings a forwardly extending portion 166. A plurality of vents, or ducts 88 are formed or inserted below spaced apart portions the forwardly extending portion 166 and above corresponding spaced apart locations of the lower panel 58. The vents or ducts 88 allow air from within the underhood area 20 to flow into the cowl box structure 150

### Third Embodiment

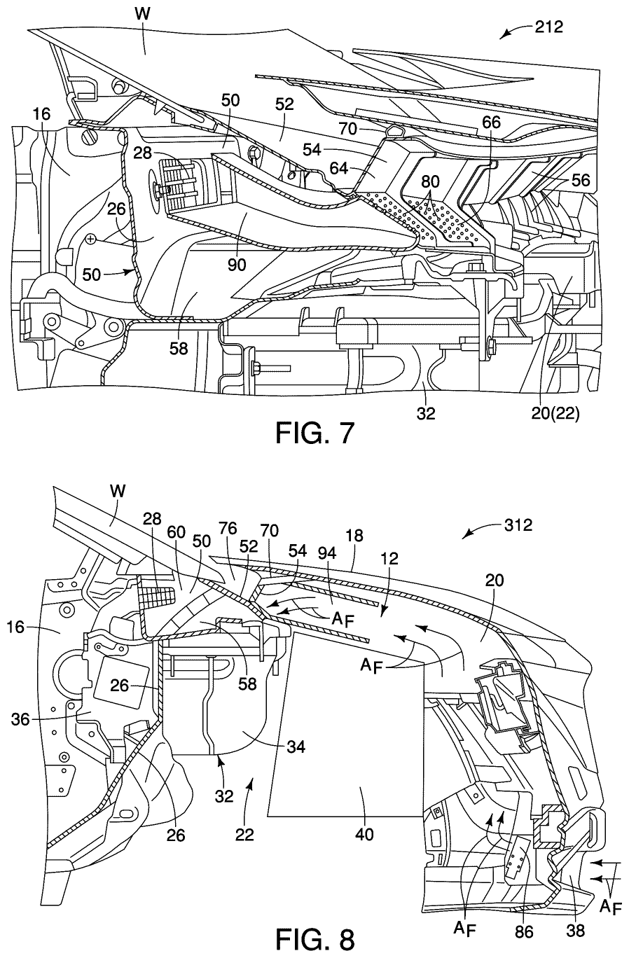

Referring now to FIGS. 6 and 7, a vehicle air flow structure 212 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

The vehicle air flow structure 212 of the third embodiment has each and every feature described above with respect to the first embodiment.

In the third embodiment, a duct 90 has been added within the tunnel 60 of the cowl box structure 50. Specifically, a first end of the duct 90 is attached to the dashwall 26 covering the opening 28 in the dashwall 26. A second end of the duct 90 is attached to the forwardly extending portion 66 of the L-shaped panel 54 such that air can flow through the openings 80 in the forwardly extending portion 66 of the L-shaped panel 54, into the duct 90 and through the opening 28 in the dashwall 26 to the air handling structure 50.

The duct 90 ensures that air flowing through the duct 90 is sealed from entering the cowl box structure 50.

### Fourth Embodiment

Referring now to FIG. 8, a vehicle air flow structure 312 in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity.

The vehicle air flow structure 312 of the fourth embodiment has each and every feature described above with respect to the first embodiment.

In the fourth embodiment, the vehicle air flow structure 312 is modified to include an inlet duct 94 that is not present in the vehicle air flow structure 12 of the first embodiment. The inlet duct 94 is fixed at one end to the forward extending portion 66 of the L-shaped panel 54 covering openings 80 in the forward extending portion 66 of the L-shaped panel 54. The inlet duct 94 extends forward from the forward extending portion 66 and overlays a portion of the electric motor 40.

The inlet duct 94 extends over the electric motor 40 within the underhood area 20 such that prior to entering the inlet duct 94 air within the underhood area 20 passes over a portion of the electric motor 40. Once within the inlet duct 94, air then passes through the plurality of openings 80 in the forwardly extending portion 66 of the L-shaped panel 54 and into the cowl box structure 50.

### Fifth Embodiment

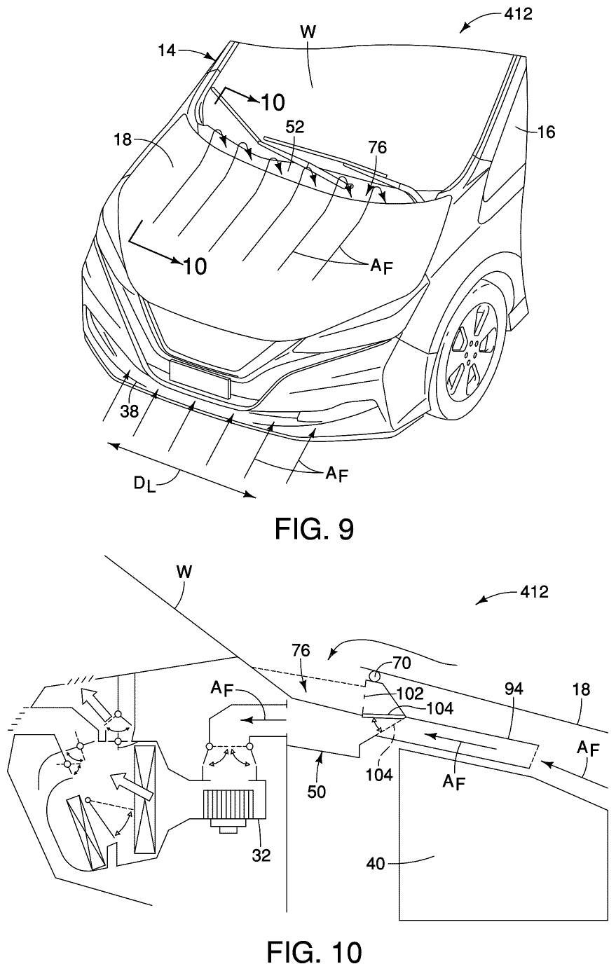

Referring now to FIGS. 9 and 10, a vehicle air flow structure 412 in accordance with a fifth embodiment will now be explained. In view of the similarity between the first and fifth embodiments, the parts of the fifth embodiment that are identical to the parts of the first embodiment will be given the same reference numerals as the parts of the first embodiment. Moreover, the descriptions of the parts of the fifth embodiment that are identical to the parts of the first embodiment may be omitted for the sake of brevity.

The vehicle air flow structure 412 in the fifth embodiment is shown schematically in FIGS. 9 and 10, and includes many of the features described above with respect to the first embodiment.

As shown in FIG. 9, air can flow into the underhood area 20 of the vehicle through the air inlet opening 38 at a lower front end of the vehicle 10. Further, the vehicle air flow structure 412 is modified so that air can flow into the cowl box structure 50 from the cowl area 76 at the lower forward end of the windscreen W.

The cowl box structure 50 is modified such that an upwardly extending portion 64 of the first embodiment is replaced with an upwardly extending portion 102 that includes a plurality of openings or a grille with openings. The upwardly extending portion 102 includes the seal 70. A valve 104 is installed above the duct 94 (of the fourth embodiment) such that the valve 104 is operated by a motor (not shown) that changes the position of the valve 104 to any of a variety of positions between an upper position shown in a solid line and a lower position in broken lines. In the upper position, the valve 104 blocks the upwardly extending portion 102 such that air cannot flow from the cowl area 70 into the cowl box structure 50. In the lower position, the valve 104 blocks the duct 94 such that air from within the underhood area 20 cannot flow from the duct 94 into the cowl box structure 50. The valve 104 is movable to any of a variety of positions between the upper position and the lower position such that various mixtures of air from the cowl area 70 and air from the underhood area 20 can be achieved, as desired based on, for example, weather conditions.

The valve 104 (a mixing valve) can be operated by a vehicle operator or can be automatically by an electronic controller (not shown) that operates automatic features of the vehicle HVAC system and other features within the vehicle based on signals from sensors installed to the vehicle body structure 14 such as temperature sensors, humidity sensors, sunlight intensity detection sensors and rain or precipitation sensors.

The electronic controller (not shown) preferably includes a microcomputer with a control program that controls the HVAC system, as discussed below. The electronic controller can also include other conventional components such as an input interface circuit, an output interface circuit, and storage devices such as a ROM (Read Only Memory) device and a RAM (Random Access Memory) device. Internal RAM of the electronic controller stores statuses of operational flags and various control data. The internal ROM of the electronic controller stores HVAC related data and control instructions for various operations.

The various vehicle structural elements and underhood features are conventional components that are well known in the art. Since these structural elements are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the vehicle air flow structures. Accordingly, these terms, as utilized to describe the present invention should be interpreted relative to a vehicle equipped with the vehicle air flow structures.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes structure, hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A vehicle air flow structure, comprising:
a vehicle body structure having a passenger compartment and a hood that covers an underhood area forward of the passenger compartment with a dashwall located between the passenger compartment and the underhood area, the dashwall having an opening;
an air handling structure attached to the dashwall; and
a cowl box structure located at least partially within the underhood area and configured to draw air from the underhood area such that prior to being drawn into the cowl box structure air passes through the underhood area and into the cowl box structure, through the opening in the dashwall and into the air handling structure.

2. The vehicle air flow structure according to claim 1, wherein
the cowl box structure has a forwardly inclined main panel and an L-shaped panel that includes an upwardly extending portion and a forwardly extending portion that is inclined in a downward direction, the main panel and the upwardly extending portion of the L-shaped panel defining a trough that directs water toward outer lateral sides of the vehicle body structure.

3. The vehicle air flow structure according to claim 2, wherein
the vehicle body structure includes a seal that is attached to and extends along an upper end of the upwardly extending portion of the L-shaped panel such that with the hood in a closed orientation, the seal is contacted by the hood such that water and air are prevented from flowing between the trough and the underhood area.

4. The vehicle air flow structure according to claim 3, wherein
the forwardly extending portion of the L-shaped panel includes a plurality of openings that allow air from within the underhood area into the cowl box structure.

5. The vehicle air flow structure according to claim 3, wherein
the cowl box structure includes a lower panel that extends forward from the dashwall and over the air handling structure with the forwardly extending portion of the L-shaped panel connecting to a forward area of the lower panel with a plurality of spaced apart ducts being defined between the forwardly extending portion of the L-shaped panel and the lower panel, the ducts being dimensioned and shaped such that air from the underhood area can flow through the ducts and into the cowl box structure.

6. The vehicle air flow structure according to claim 4, wherein
the cowl box structure includes a duct that extends from the plurality of openings in the forwardly extending portion of the L-shaped panel to the opening in the dashwall such that air flowing through the duct is sealed from entering the cowl box structure.

7. The vehicle air flow structure according to claim 4, wherein
the underhood area defines a power plant compartment with an electric motor being located within the power plant compartment and attached to the vehicle body structure.

8. The vehicle air flow structure according to claim 7, further comprising
an inlet duct that extends over the electric motor within the underhood area and to the forwardly extending portion of the L-shaped panel such that air entering the inlet duct passes over a portion of the electric motor, into the inlet duct, through the plurality of openings in the forwardly extending portion of the L-shaped panel and into the cowl box structure.

9. The vehicle air flow structure according to claim 8, wherein
the electric motor is the sole source of propulsion for the vehicle body structure.

10. The vehicle air flow structure according to claim 1, wherein
the cowl box structure has a forwardly inclined main panel and a forwardly extending portion that is inclined in a downward direction, the main panel and the forwardly extending portion defining an upper inlet opening such that air can pass through the upper inlet opening from above the hood and into the cowl box structure.

11. The vehicle air flow structure according to claim 10, wherein
the cowl box structure includes an air mixing valve located at an intersection of the upper inlet opening and an opening in the cowl box structure adjacent to the upper inlet opening, the mixing valve being operable to adjust a mixture of air flowing from the upper inlet opening and the opening in the cowl box structure.

12. The vehicle air flow structure according to claim 11, wherein
the main panel of the cowl box structure at least partially defines a trough that directs water toward outer lateral sides of the vehicle body structure.

13. The vehicle air flow structure according to claim 1, wherein
the vehicle body structure includes an air inlet opening located at a lower front area of the underhood area that provides fresh air to the underhood area.

14. The vehicle air flow structure according to claim 13, further comprising
a heat exchanger installed within the underhood area adjacent to and rearward of the air inlet opening, the heat exchanger being part of an HVAC system.

15. The vehicle air flow structure according to claim 14, further comprising
the air handling structure defines a portion of the HVAC system with a first portion of the air handling structure being located within the underhood area and a second portion being located within the passenger compartment, and
the opening in the dashwall directs air into the second portion of the air handling structure.

16. A vehicle air flow structure, comprising:
a vehicle body structure having a passenger compartment, a hood and a power plant compartment with dashwall located between the passenger compartment and the power plant compartment;
an electric motor being located within the power plant compartment and attached to the vehicle body structure;
a cowl box structure located at an upper rearward portion of the power plant compartment adjacent to the dashwall, the dashwall having an opening that is open to both the passenger compartment and a cowl tunnel defined within the cowl area; and
an air handling structure located at least partially within the passenger compartment configured to draw air from the power plant compartment via the opening in the dashwall and the cowl box structure such that prior to being drawn into the air handling structure air passes along a portion of the electric motor, then moves into the cowl box structure, through the opening in the dashwall and into the air handling structure.

17. The vehicle air flow structure according to claim 13, further comprising
a structure overlays an upper area of the electric motor, a first end of the duct being attached to and in fluid communication with the cowl box structure and a second end located above the electric motor.
